(19) United States
(12) Patent Application Publication
(10) Pub. No.: US 2024/0124724 A1
(43) Pub. Date: Apr. 18, 2024

(54) Compositions for Improving the Environmental Impact of Printing and Dyeing

(71) Applicant: Locus Solutions IPCo, LLC, Solon, OH (US)

(72) Inventors: Sean FARMER, Ft. Lauderdale, FL (US); Andrew R. LEFKOWITZ, Solon, OH (US)

(21) Appl. No.: 18/010,886

(22) PCT Filed: Aug. 30, 2022
(86) PCT No.: PCT/US2022/042054

§ 371 Date: Dec. 16, 2022

Related U.S. Application Data
(60) Provisional application No. 63/238,427, filed on Aug. 30, 2021.

(51) Int. Cl. C09D 11/03; C09D 9/04; D06P 1/651; D21H 19/46

(52) U.S. Cl. CPC C09D 11/03; C09D 9/04; D06P 1/65131; D21H 19/46

(57) ABSTRACT

The subject invention provides environmentally-friendly compositions and methods for enhancing the printing and dyeing of goods such as paper and textiles. In certain embodiments, the methods of the subject invention comprise incorporating the application of a biological amphiphilic molecule into a printing or dyeing process to reduce chemical usage, reduce water usage, reduce water pollution and/or provide an added benefit to the process. In certain embodiments, the methods of the subject invention comprise substituting a chemical surfactant with a biological amphiphilic molecule in one or more steps involved in printing and/or dyeing that would traditionally utilize a chemical surfactant.

### CROSS-REFERENCE TO RELATED APPLICATION

This application claims priority to U.S. Provisional Patent application Ser. No. 63/238,427, filed Aug. 30, 2021, which is incorporated herein by reference in its entirety.

### BACKGROUND OF THE INVENTION

Surfactants are surface-active, amphiphilic molecules with potential applications in many areas of industry. Accordingly, the market for surfactants, which currently consists of thousands of different surface-active molecules, is growing rapidly. About 60% of surfactants are used as detergents and compounds for personal care products. Other uses include, for example, pharmaceuticals and supplements; paper and textiles; oil and gas recovery; bioremediation; agriculture; cosmetics; coatings and paints; food production and processing; and construction.

The properties of a surface-active molecule can be measured by hydrophile-lipophile balance (HLB). HLB is the balance of the size and strength of the hydrophilic and lipophilic moieties of a surface-active molecule. Specific HLB values are required to, for example, form a stable emulsion. In water/oil and oil/water emulsions, the polar moiety of the surface-active molecule orients towards the water, and the non-polar group orients towards the oil, thus lowering the interfacial tension between the oil and water phases.

HLB values range from 0 to about 20, with lower HLB (e.g., 10 or less) being more oil-soluble and suitable for water-in-oil emulsions, and higher HLB (e.g., 10 or more) being more water-soluble and suitable for oil-in-water emulsions. Other properties, such as foaming, wetting, detergency and solubilizing capabilities, are also dependent upon HLB.

Synthetic and chemical surfactants are advantageous because they can be easy to produce and can be tailored to perform a desired function based on their molecular structure. Thus, thousands of different surfactants have been developed, each having a certain narrow function. While this leaves ample options to choose from when producing products in which surfactants are used, the specificity of surfactant functions means that more varieties and combinations of surfactants are required for producing products with multiple functions. For example, a surfactant useful as a wetting agent may not necessarily be useful as a detergent, and a surfactant useful as an emulsifier may not necessarily be useful as an anti-corrosion agent.

The result is the over-use and over-production of chemical surfactants over the course of many decades. With growing consumer and regulatory awareness, the shortcomings of chemical surfactants are beginning to surface, including, for example, their potential and known toxicity to humans and animals; persistence in the environment, including aquatic environments, soil and ground water; contribution to climate change during production and application; and incompatibility with other chemicals.

One example of an industry with high environmental impacts that utilizes surfactants is the printing industry. Printing involves the marking of a surface, such as a textile, garment, or paper, with a text, image, design or pattern.

There are several different types of printing, ranging from manual stamping to machine-automated mass-scale printing. In offset printing, a plate or block made of, for example, aluminum or wood is carved or etched to contain a design. Ink is spread onto the relief plate or block and then transferred to the desired surface, e.g., textiles or paper, using pressure to produce an impression.

Flexography printing is similar to offset printing, except the relief plate is a flexible material, typically a polymer. This allows for high-speed rotary printing on almost any type of substrate, including plastic, metallic films, cellophane and paper. For each color that is to be printed, a separate plate must be made and loaded with an individual color, which is then printed in line to overlap previously printed colors and form the design.

Screen printing involves the use of a fine mesh screen made of polyester, nylon, or metal that is stretched inside a frame or rolled onto a metal cylinder. A blocking stencil is drawn onto the screen, creating a negative of the desired design. Then, the screen is placed or rolled over the substrate and ink is passed through the areas of the screen that are not blocked, thereby creating a design on the substrate. Screen printing is a common method for printing on garments.

Lastly, another common printing method is digital printing, which includes, for example, inkjet and laser printing. A digital file can easily be converted into a printed image or text, with all colors being printed at one time rather than separately.

In inkjet printing, a printed pattern is progressively built up directly onto the substrate using nozzles that deposit a large number of individual drops of ink. Laser printing involves the repeated passing of a laser beam over a negatively charged cylinder called a “drum,” which selectively collects electrically charged powdered ink (toner) and transfers the ink to paper as an image. The paper is then heated to permanently fuse the image to the paper.

Printing requires the use of a colorant to impart an image or design onto a substrate. Both dyes and pigments are used as colorants in printing inks. In pigment-based inks (dry printing), the colorant exists as a colloidal system of fine pigment particles dispersed in solvent. The solvent may be aqueous or organic.

In dye-based inks (wet printing), which are more commonly used in writing utensils and textiles, the colorant exists in the form of a solution, or in the form of a latex dispersion or polymeric microemulsion impregnated with a dye. The majority of water-soluble dyes are ionic compounds. Compared with dye-based inks, the pigments in printing inks are not typically water soluble. Thus, pigments will tend to remain at the surface of a substrate when applied, with some particles locating in between fibers, rather than saturating and chemically binding to the substrate like dyes.

Modern day ink formulations can be complex, comprising, in addition to the pigment, other additives for application and performance. These additional ingredients can include, for example, solvents and co-solvents (to serve as a carrier medium and for controlling wetting and drying properties, respectively); dispersants/emulsifiers (to keep pigments in suspension); humectants (to reduce premature drying and crusting on equipment); binders (to ensure fixation of the colorant onto the substrate); spreading and/or wetting agents (to control the spreading and penetration of ink over the substrate); biocides (to suppress biological growth); pH modifiers, solubilizers, anti-curl agents, defoamers, and/or thickeners, all of which can be fine-tuned based on the type of printing process and the equipment and substrate used. In some textile printing, additional gums or starches may be added to produce a more paste-like ink.

Many ink formulations utilize harsh solvents, as well as chemical surfactants and synthetic polymers. There is, however, a growing desire to exclude organic solvents to limit the release of volatile organic compounds (VOC) in ink formulations. As a result, there has been a push to replace these solvents with water. Water-based inks, however, require specific additives to lower the surface tension of the water so that the surface of the substrate is more receptive to wetting and interaction with the pigments. Surfactants do this by aggregating on the surface layers at the liquid-air and solid-liquid interfaces. This may able be useful in solvent-based inks as well. Examples of wetting agents in printing include, but are not limited to, sodium benzoate, sodium salicylate, ethoxylated acetylenic diols, sodium benzene sulfonate, alkyl- and alklaryl sulfonates, and alkyl sulfosuccinates.

Additional uses for surfactants in printing include dispersion and stabilization. Pigmented inks are prepared by incorporating the pigment in the continuous phase by a milling and dispersing process. The pigment particles may aggregate during storage or application, which affects the size and shape of pigment particles, and in turn, dictates the color intensity, shade and light fastness. Thus, pigmented inks require a dispersant in the pigment slurry during the milling process to produce a colloidally-stable mixture and an ink that can be jetted reliably without clogging print head nozzles. These dispersants are typically polymers and/or surfactants. The surfactant and/or polymer adsorbs to the pigment particles and forms a coating thereon, with the aim of causing the particles to repel each other rather than aggregating. Additionally, by balancing the surface tension of certain colorant pigments, surfactants may help to minimize inter-color bleeding and mottling.

Examples of surfactant dispersants in printing include, but are not limited to, sodium alkyl sulfates, sodium dodecylbenzene sulfonate, dialkyl benzenealkyl ammonium chloride, alkyl sulphobetaines and polyoxyethylene alkyl ethers.

Furthermore, surfactants can be useful for the cleaning and maintenance of printing equipment. By preventing and/or removing ink deposits in nozzles, heaters, rotary presses, in wells, and screens, for example, the quality of printing can be maintained, as well as the functioning of the equipment. Phosphate esters are a common suitable surfactant utilized for this purpose, as well as non-surfactant polyphosphates, surfynols or acetylenols.

One consideration when selecting surfactants for ink chemistry is that many ionic surfactants tend to stabilize foams. Foam formation in ink can hinder ink flow and cause bubbles and puddling of ink at the nozzle, resulting in misdirected drops of ink onto the substrate. Thus, additional surfactants may be required to serve as de-foamers or anti-foaming agents, which penetrate the liquid-air interface in the foam to slow formation. Otherwise, foam-stabilizing surfactants should be avoided and/or substituted with surfactants having foam destabilizing properties.

In addition to printing of substrates, dyeing of textiles, paper, and other fibrous materials often utilize similar compositions to impart a uniform color. More specifically, dyeing involves the movement of dye molecules into the internal parts of a fiber, where the dye molecules adsorb onto the fiber structure and diffuse throughout. Surfactant-based dispersants and wetting agents support the uniform dispersion of the dyes in the dyeing media, and proper penetration of the dyeing solution into the fiber matrix. The dyeing process can be carried out on raw fibers, yarns, skeins or spools of yarns or threads, threads, cloths, fabric pieces and finished garments, as well as paper pulp and finished paper. Typically, the specific material to be dyed is submerged in or sprayed with a liquid form dye. Other methods utilize carbon dioxide or other vehicles for the dye rather than water.

A large proportion of the impact caused by the dyeing industry is due the large consumption of water and textile auxiliaries. After dyeing textiles, for example, a heated aging process is often used to help seal colorants in place. The added environmental impact comes from washing the textile after the sealing, where a detergent is used to remove excess treatment, such as colorants, thickeners and byproducts of the print or dye material. These can lead to over use of chemicals, as well as excess water usage and water pollution.

Printing and dyeing of textiles, paper, packaging and other everyday materials are chemical-intensive and water-intensive processes with several potential negative environmental and health implications. Accordingly, there is a need for improved compositions and methods for printing and dyeing with reduced environmental and health impacts.

### SUMMARY OF THE INVENTION

The subject invention provides environmentally-friendly compositions and methods for improving production of printed and dyed materials such as textiles, paper goods and packaging. More specifically, the subject invention provides “green” alternatives for chemicals utilized in the inks and processes used for printing and dyeing. Advantageously, the compositions and methods can help reduce water and chemical usage resulting from these processes, as well as reduce wastewater pollution.

In certain embodiments, the compositions and method of the subject invention incorporate the use of a “green” molecule into a printing or dyeing process to reduce chemical usage, reduce water usage, reduce water pollution and/or provide an added benefit to the process. In certain embodiments, the methods of the subject invention comprise substituting a chemical surfactant with a “green” molecule in an ink used for printing or dyeing. In certain embodiments, the methods comprise substituting the green molecule in one or more steps involved in a printing or dyeing process that would traditionally utilize a chemical surfactant.

In some embodiments, the “green” molecule is a biological amphiphilic molecule, which can be utilized as, for example, a detergent, a lubricant, an emulsifier, a solubilizer, a wetting agent, a dispersant, an antimicrobial, or in other functions in the process of printing on or dyeing a textile good, paper good, or other surface, or a raw material thereof.

Furthermore, in some embodiments, the biological amphiphilic molecule can be utilized as an adjuvant or additive for improving the performance of, for example, printing inks, dyes, solvents, detergents, lubricants, finishing agents, antimicrobials, emulsifiers, or other treatments utilized in the printing or dyeing of surfaces, as well as improving the performance and maintenance of equipment utilized for printing and/or dyeing.

In certain specific embodiments, the subject invention provides an ink composition for printing or dyeing a surface, wherein the composition comprises a colorant and a biological amphiphilic molecule.

In certain embodiments, the colorant is a pigment or a dye. In some embodiments, the colorant can be in the form of particles and/or nanoparticles having a size from e.g., 10 nm to 1,000 nm.

The composition can be produced by mixing the colorant with the biological amphiphilic molecule in water and/or another solvent. In some embodiments, the biological amphiphilic molecule forms a micelle in which the colorant is encapsulated. In certain embodiments, the colorant mixture is then added to a water or solvent to produce a water- or solvent-based ink or dye.

Optionally, the composition can also comprise one or more additives, including, for example, carriers, solvents, co-solvents, dispersants, emulsifiers, humectants, binders, wetting agents, biocides, pH modifiers, solubilizers, anti-curl agents, mordants, defoamers, anti-foamers, detergents, and/or thickeners. In certain embodiments, the biological amphiphilic molecule can serve the function of one or more of these additives.

In certain embodiments, methods are provided for improving the environmental impact of printing and/or dyeing surfaces, wherein the method comprises applying a biological amphiphilic molecule according to the subject invention to the surface in place of, and/or in addition to, a chemical active, additive or adjuvant that would traditionally be utilized in one or more compositions and/or steps involved in printing or dyeing.

In certain embodiments, the method comprises applying an ink composition according to the subject invention to a surface such that the ink and/or colorant therein becomes fixed onto or into the surface. In certain embodiments, the biological amphiphilic molecule facilitates the delivery of the colorant to the surface so that fixing can occur. In certain embodiments, the biological amphiphilic molecule serves one or more of the following purposes: a wetting agent, a solubilizer, a dispersant, an emulsifier, a viscosity modifier, a detergent, and anti-foaming agent, and/or a biocide.

The surface can be, for example, a textile or garment, or a fiber, yarn, thread, cloth, or fabric raw material of the textile or garment; a paper good, or a pulp raw material of the paper good; and/or packaging, polymer, wrapping, ceramic, wood, or any raw material thereof.

In certain embodiments, the biological amphiphilic molecule can be applied as a post-print or post-dye detergent to remove excess components of ink compositions from the surface after drying, curing and/or sealing.

In certain embodiments, the biological amphiphilic molecule can be utilized as a de-inking agent, or detergent, for removing printing ink from waste-paper, waste-paper pulp, textiles, and polymers in preparation for recycling and re-use. The biological amphiphilic molecule can be applied to the material intended to be de-inked, wherein the biological amphiphilic molecule helps detach the ink therefrom. As an example, waste-paper pulp can be mixed with water, and the biological amphiphilic molecule is added to facilitate the flotation of the ink to the surface for removal.

In one embodiment, the method comprises applying the biological amphiphilic molecule to printing and/or dyeing equipment as a detergent or cleaning composition to clean, enhance and/or maintain the performance of the equipment. For example, the equipment can be a roller, a screen, or a nozzle.

In certain embodiments, the subject methods further comprise testing one or more of print quality, block resistance, foaming, scrubbing, light fastness, bleeding, shear stability, gloss, water resistance, adhesion and drying, and adjusting the process as needed based on testing results. This can include, for example, cleaning equipment and/or adding a biological amphiphilic molecule to one or more steps in the printing or dyeing process.

In certain embodiments, the subject invention provides a printed and/or dyed product that has an ink composition according to the subject invention fixed thereon or therein, wherein the product is, for example, a textile, garment, paper, packaging, wrapping, polymer, ceramic, wood, or raw material thereof.

In preferred embodiments, the biological amphiphilic molecule is a glycolipid biosurfactant (e.g., sophorolipids, rhamnolipids, cellobiose lipids, mannosylerythritol lipids and/or trehalose lipids). In some embodiments, other biosurfactants can be utilized, such as, for example, lipopeptides (e.g., surfactin, iturin, fengycin, arthrofactin and/or lichenysin), flavolipids, phospholipids (e.g., cardiolipins), fatty acid ester compounds, and high molecular weight polymers such as lipoproteins, lipopolysaccharide-protein complexes, and polysaccharide-protein-fatty acid complexes.

In certain embodiments, the methods utilize a composition comprising one or more sophorolipid (SLP) molecules and/or a yeast culture comprising a SLP molecule. The SLP molecule can be, for example, an acidic (linear) SLP (ASL), lactonic SLP (LSL), di-acetylated SLP, mono-acetylated SLP, esterified SLP, amino-acid-SLP conjugates, metal-SLP conjugates, salt form SLP, SLP amino alcohols, SLP with carbonyl groups removed from the aliphatic chain, and/or any other derivatives of SLP molecules. The SLP molecule(s) can be in a pure form or crude form.

In certain embodiments, the present invention utilizes yeast strains and/or by-products of their growth. For example, in some embodiments, the methods comprise application of a microbe-based product comprising cultivated Starmerella bombicola ATCC 22214 and/or products of the growth of that microbe, such as SLP. In certain embodiments, the yeast in the composition can be inactive and/or in various growth states, such as, for example, vegetative or spore forms. In certain other embodiments, the yeast cells are removed from the culture so that broth, microbial growth by-products and, in some instances, small amounts of residual cellular matter remain for use.

Advantageously, SLP, when used according to the subject invention, have several benefits that make them ideal for use in printing and dyeing. First, their excellent wetting ability helps facilitate a reduction in the usage of water and chemical wetting agents; thus, they can contribute to reduced water pollution and wastewater treatment. Additionally, in their natural state, their mildly anionic properties make them compatible with natural and synthetic fibers. Furthermore, SLP are multifunctional, low foaming, have a low critical micelle concentration (CMC), and are biodegradable.

### DETAILED DESCRIPTION

The subject invention provides environmentally-friendly compositions and methods for improving production of printed and dyed materials such as textiles, paper goods and packaging. More specifically, the subject invention provides “green” alternatives for chemicals utilized in the inks and processes used for printing and dyeing. Advantageously, the compositions and methods can help reduce water and chemical usage resulting from these processes, as well as reduce wastewater pollution.

In certain embodiments, the compositions and method of the subject invention incorporate the use of a “green” molecule into a printing or dyeing process to reduce chemical usage, reduce water usage, reduce water pollution and/or provide an added benefit to the process.

In certain embodiments, the methods of the subject invention comprise substituting a chemical surfactant with a “green” molecule in an ink used for printing or dyeing. In certain embodiments, the methods comprise substituting the green molecule in one or more steps involved in a printing or dyeing process that would traditionally utilize a chemical surfactant.

### Selected Definitions

As used herein, a “green” compound or material means at least 95% derived from natural, biological and/or renewable sources, such as plants, animals, minerals and/or microorganisms, and furthermore, the compound or material is biodegradable. Additionally, “green” compounds or materials are minimally toxic to humans and have a LD50>5000 mg/kg. A “green” product preferably does not contain any of the following: non-plant based ethoxylated surfactants, linear alkylbenzene sulfonates (LAS), ether sulfates surfactants or nonylphenol ethoxylate (NPE).

As used herein, a “biofilm” is a complex aggregate of microorganisms, such as bacteria, yeast, or fungi, wherein the cells adhere to each other and/or to a surface using an extracellular matrix. The cells in biofilms are physiologically distinct from planktonic cells of the same organism, which are single cells that can float or swim in liquid medium.

As used herein, an “isolated” or “purified” nucleic acid molecule, polynucleotide, polypeptide, protein or organic compound such as a small molecule (e.g., those described below), is substantially free of other compounds, such as cellular material, with which it is associated in nature. A purified or isolated polynucleotide (ribonucleic acid (RNA) or deoxyribonucleic acid (DNA)) is free of the genes or sequences that flank it in its naturally-occurring state. A purified or isolated polypeptide is free of the amino acids or sequences that flank it in its naturally-occurring state. An isolated microbial strain means that the strain is removed from the environment in which it exists in nature. Thus, the isolated strain may exist as, for example, a biologically pure culture, or as spores (or other forms of the strain) in association with a carrier.

In certain embodiments, purified compounds are at least 60% by weight the compound of interest. Preferably, the preparation is at least 75%, more preferably at least 90%, and most preferably at least 98%, by weight the compound of interest. For example, a purified compound is one that is at least 80%, 85%, 90%, 91%, 92%, 93%, 94%, 95%, 98%, 99%, or 100% (w/w) of the desired compound by weight. Purity is measured by any appropriate standard method, for example, by column chromatography, thin layer chromatography, or high-performance liquid chromatography (HPLC) analysis.

A “metabolite” refers to any substance produced by metabolism or a substance necessary for taking part in a particular metabolic process. A metabolite can be an organic compound that is a starting material, an intermediate in, or an end product of metabolism. Examples of metabolites include, but are not limited to, enzymes, acids, solvents, alcohols, proteins, vitamins, minerals, microelements, amino acids, biopolymers and biosurfactants.

As used herein, reference to a “microbe-based composition” means a composition that comprises components that were produced as the result of the growth of microorganisms or other cell cultures. Thus, the microbe-based composition may comprise the microbes themselves and/or by-products of microbial growth. The microbes may be in a vegetative state, in spore form, in mycelial form, in any other form of propagule, or a mixture of these. The microbes may be planktonic or in a biofilm form, or a mixture of both. The by-products of growth may be, for example, metabolites, cell membrane components, expressed proteins, and/or other cellular components. The microbes may be intact or lysed. The microbes may be present in or removed from the composition. The microbes can be present, with broth in which they were grown, in the microbe-based composition. The cells may be present at, for example, a concentration of at least 1×10³, 1×10⁴, 1×10⁵, 1×10⁶, 1×10⁷, 1×10⁸, 1×10⁹, 1×10¹⁰, 1×10¹¹, 1×10¹², 1×10¹³ or more CFU per milliliter of the composition.

The subject invention further provides “microbe-based products,” which are products that are to be applied in practice to achieve a desired result. The microbe-based product can be simply the microbe-based composition harvested from the microbe cultivation process. Alternatively, the microbe-based product may comprise further ingredients that have been added. These additional ingredients can include, for example, stabilizers, buffers, carriers, such as water, salt solutions, or any other appropriate carrier, added nutrients to support further microbial growth, non-nutrient growth enhancers, and/or agents that facilitate tracking of the microbes and/or the composition in the environment to which it is applied. The microbe-based product may also comprise mixtures of microbe-based compositions. The microbe-based product may also comprise one or more components of a microbe-based composition that have been processed in some way such as, but not limited to, filtering, centrifugation, lysing, drying, purification and the like.

Ranges provided herein are understood to be shorthand for all of the values within the range. For example, a range of 1 to 20 is understood to include any number, combination of numbers, or sub-range from the group consisting 1, 2, 3, 4, 5, 6, 7, 8, 9, 10, 11, 12, 13, 14, 15, 16, 17, 18, 19 and 20, as well as all intervening decimal values between the aforementioned integers such as, for example, 1.1, 1.2, 1.3, 1.4, 1.5, 1.6, 1.7, 1.8, and 1.9. With respect to sub-ranges, “nested sub-ranges” that extend from either end point of the range are specifically contemplated. For example, a nested sub-range of an exemplary range of 1 to 50 may comprise 1 to 10, 1 to 20, 1 to 30, and 1 to 40 in one direction, or 50 to 40, 50 to 30, 50 to 20, and 50 to 10 in the other direction.

As used herein, a “raw material” includes any basic material from which a product is made. In certain embodiments, the raw material has been unaltered from its natural state. In certain embodiments, the raw material has been treated in some way, for example, in a previous step as part of a process. Thus, the raw material can be a starting material, and/or it can be an intermediary material in a process.

As used herein a “reduction” means a negative alteration, and an “increase” means a positive alteration, wherein the negative or positive alteration is at least 0.001%, 0.01%, 0.1%, 0.5%, 1%, 5%, 10%, 15%, 20%, 25%, 30%, 35%, 40%, 45%, 50%, 55%, 60%, 65%, 70%, 75%, 80%, 85%, 90%, 95% or 100%.

As used herein, “surfactant” means a compound that lowers the surface tension (or interfacial tension) between two liquids or between a liquid and a solid. Surfactants act as, e.g., detergents, wetting agents, emulsifiers, foaming agents, and/or dispersants. A “biosurfactant” is a surface-active substance produced by a living cell and/or using naturally-derived substrates.

Biosurfactants are a structurally diverse group of surface-active substances consisting of two parts: a polar (hydrophilic) moiety and non-polar (hydrophobic) group. Due to their amphiphilic structure, biosurfactants can, for example, increase the surface area of hydrophobic water-insoluble substances, increase the water bioavailability of such substances, and change the properties of bacterial cell surfaces. Biosurfactants can also reduce the interfacial tension between water and oil and, therefore, lower the hydrostatic pressure required to move entrapped liquid to overcome the capillary effect. Biosurfactants accumulate at interfaces, thus reducing interfacial tension and leading to the formation of aggregated micellar structures in solution. The formation of micelles provides a physical mechanism to mobilize, for example, oil in a moving aqueous phase.

The ability of biosurfactants to form pores and destabilize biological membranes also permits their use as antibacterial, antifungal, and hemolytic agents to, for example, control pests and/or microbial growth.

Typically, the hydrophilic group of a biosurfactant is a sugar (e.g., a mono-, di-, or polysaccharide) or a peptide, while the hydrophobic group is typically a fatty acid. Thus, there are countless potential variations of biosurfactant molecules based on, for example, type of sugar, number of sugars, size of peptides, which amino acids are present in the peptides, fatty acid length, saturation of fatty acids, additional acetylation, additional functional groups, esterification, polarity and charge of the molecule.

These variations lead to a group of molecules comprising a wide variety of classes, including, for example, glycolipids (e.g., sophorolipids, rhamnolipids, cellobiose lipids, mannosylerythritol lipids and trehalose lipids), lipopeptides (e.g., surfactin, iturin, fengycin, arthrofactin and lichenysin), flavolipids, phospholipids (e.g., cardiolipins), fatty acid ester compounds, and high molecular weight polymers such as lipoproteins, lipopolysaccharide-protein complexes, and polysaccharide-protein-fatty acid complexes. Each type of biosurfactant within each class can further comprise subtypes having further modified structures.

Like chemical surfactants, each biosurfactant molecule has its own HLB value depending on its structure; however, unlike production of chemical surfactants, which results in a single molecule with a single HLB value or range, one cycle of biosurfactant production typically results in a mixture of biosurfactant molecules (e.g., subtypes and isomers thereof).

The phrases “biosurfactant” and “biosurfactant molecule” include all forms, analogs, orthologs, isomers, and natural and/or anthropogenic modifications of any biosurfactant class (e.g., glycolipid) and/or subtype thereof (e.g., sophorolipid).

As used herein, the term “sophorolipid,” “sophorolipid molecule,” “SLP” or “SLP molecule” includes all forms, derivatives, and isomers thereof, of SLP molecules, including, for example, acidic (linear) SLP (ASL) and lactonic SLP (LSL). Further included are, for example, di-acetylated SLP, mono-acetylated SLP, esterified SLP, amino-acid-SLP conjugates, metal-SLP conjugates, salt form SLP, SLP amino alcohols, SLP with carbonyl groups removed from the aliphatic chain, and/or any other derivatives of SLP molecules.

The SLP molecules according to the subject invention can be represented by General Formula (1) and/or General Formula (2), and are obtained as a collection of 30 or more types of structural homologues having different fatty acid chain lengths (R 3), and, in some instances, having an acetylation or protonation at R¹ and/or R².

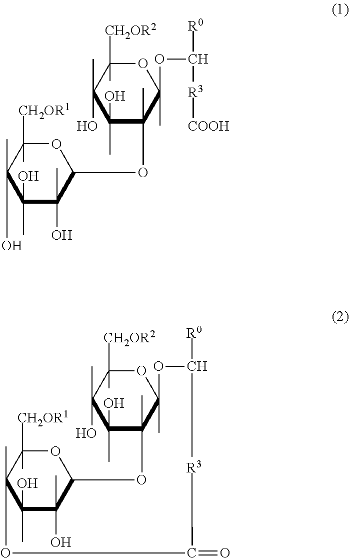

In General Formula (1) or (2), R⁰ can be either a hydrogen atom or a methyl group. R¹ and R² are each independently a hydrogen atom or an acetyl group. R 3 is a saturated aliphatic hydrocarbon chain, or an unsaturated aliphatic hydrocarbon chain having at least one double bond, and may have one or more Substituents.

Examples of the Substituents include halogen atoms, hydroxyl, lower (C1-6) alkyl groups, halo lower (C1-6) alkyl groups, hydroxy lower (C1-6) alkyl groups, halo lower (C1-6) alkoxy groups, and others. R 3 typically has up to 20 carbon atoms.

The transitional term “comprising,” which is synonymous with “including,” or “containing,” is inclusive or open-ended and does not exclude additional, unrecited elements or method steps. By contrast, the transitional phrase “consisting of” excludes any element, step, or ingredient not specified in the claim. The transitional phrase “consisting essentially of” limits the scope of a claim to the specified materials or steps “and those that do not materially affect the basic and novel characteristic(s)” of the claimed invention. Use of the term “comprising” contemplates other embodiments that “consist” or “consist essentially of” the recited component(s).

Unless specifically stated or obvious from context, as used herein, the term “or” is understood to be inclusive. Unless specifically stated or obvious from context, as used herein, the terms “a,” “and” and “the” are understood to be singular or plural.

Unless specifically stated or obvious from context, as used herein, the term “about” is understood as within a range of normal tolerance in the art, for example within 2 standard deviations of the mean. About can be understood as within 10%, 9%, 8%, 7%, 6%, 5%, 4%, 3%, 2%, 1%, 0.5%, 0.1%, 0.05%, or 0.01% of the stated value. Unless otherwise clear from context, all numerical values provided herein are modified by the term about.

The recitation of a listing of chemical groups in any definition of a variable herein includes definitions of that variable as any single group or combination of listed groups. The recitation of an embodiment for a variable or aspect herein includes that embodiment as any single embodiment or in combination with any other embodiments or portions thereof.

All references cited herein are hereby incorporated by reference in their entirety.

### Compositions and Methods for Printing and Dyeing Surfaces

The subject invention provides environmentally-friendly compositions and methods for improving production of printed materials such as textiles, paper goods and packaging. More specifically, the subject invention provides “green” alternatives for chemicals utilized in the inks and processes used for printing and dyeing. Advantageously, the compositions and methods can help reduce water and chemical usage resulting from these processes, as well as reduce wastewater pollution.

In certain embodiments, the compositions and method of the subject invention incorporate the use of a “green” molecule into a printing or dyeing process to reduce chemical usage, reduce water usage, reduce water pollution and/or provide an added benefit to the process. In certain embodiments, the methods of the subject invention comprise substituting a chemical surfactant with a “green” molecule in an ink used for printing or dyeing. In certain embodiments, the methods comprise substituting the green molecule in one or more steps involved in a printing or dyeing process that would traditionally utilize a chemical surfactant.

In some embodiments, the “green” molecule is a biological amphiphilic molecule, which can be utilized as, for example, a detergent, a lubricant, an emulsifier, a solubilizer, a wetting agent, a dispersant, an antimicrobial, or in other functions in the process of printing on or dyeing a textile good, paper good, or other surface, or a raw material thereof.

Furthermore, in some embodiments, the biological amphiphilic molecule can be utilized as an adjuvant or additive for improving the performance of, for example, printing inks, dyes, solvents, detergents, lubricants, finishing agents, antimicrobials, emulsifiers, or other treatments utilized in the printing or dyeing of surfaces, as well as improving the performance and maintenance of equipment utilized for printing and/or dyeing.

### Ink Compositions

In certain specific embodiments, the subject invention provides an ink composition for printing or dyeing a surface, wherein the composition comprises a colorant and a biological amphiphilic molecule.

The biological amphiphilic molecule can be present in an amount between 0.01 and 50%, 0.1 and 35%, 0.25 and 25%, or 0.5 and 20% by weight relative to the weight of the composition.

In certain embodiments, the biological amphiphilic molecule is selected based on the properties of the colorant being utilized. For example, a cationic colorant would typically not be utilized with an anionic amphiphilic molecule, and vice versa. Otherwise, the result may be precipitation of the colorant from the composition. The skilled artisan would understand, having the benefit of the subject description, how to formulate the composition based on these considerations.

In certain embodiments, the colorant is a pigment or a dye. In certain embodiments, the colorant is selected from a known compound classified within the Color Index International database.

As used herein, “pigments” are colored, black, white or fluorescent particulate organic or inorganic solids that are generally insoluble in the vehicle or substrate in which they are incorporated. They alter appearance by selective absorption and/or by scattering of light. Pigments are usually dispersed in vehicles or substrates for application, as for instance in the manufacture of inks, paints, plastics or other polymeric materials. Pigments retain a crystal or particulate structure throughout the coloration process.

As used herein, “dyes” are intensely colored or fluorescent organic substances, which impart color to a substrate by selective absorption of light. They are soluble and/or are applied in a way that, at least temporarily, destroys any crystal structure by absorption, solution, and mechanical retention, or by ionic or covalent chemical bonds.

In some embodiments, the colorant is a pigment comprising particles and/or nanoparticles having a size from e.g., 0.01 nm to 1,000 nm, or from 0.1 to 100 nm, or from 0.25 to 10 nm, or from 0.5 to 1 nm. The pigments particles may be obtained by grinding a commercially available pigment compound using, e.g., a ball grinder.

Non-limiting examples of inorganic pigment particles include purple pigments: Ultramarine violet (PV15; Na₆Al₆Si₆O₂₄S₄), Han Purple (BaCuSi₂0₆), Cobalt Violet (PV14; Co3(PO₄)2), and Manganese violet (PV16; NH₄MnP₂0₇);

blue pigments: Ultramarine blue (PB29; Na₆Al₆Si₆O₂₄S₄), Cobalt Blue (PB28) and Cerulean Blue (PB35) cobalt(II) stannate, Egyptian Blue (CaCuSi₄O₁₀), Han Blue (BaCuSi₄O₁₀), Azurite (Cu₃(C0₃)2(OH)₂), Prussian Blue (PB27; Fe₇(CN)₁₈), YInMn Blue (Y1-xMnx0₃), and selected copper phtalocyanines;

green pigments: Chrome green (PG17; Cr₂0₃), Viridian (PG18; Cr₂0₃·H₂0), Cobalt green or Rinman's green or Zinc green (CoZn0₂), Malachite (Cu₂C0₃(OH)₂), Paris Green (Cu(C₂H₃0₂)₂-3Cu(As0₂)₂), Scheele's Green or Schloss Green (CuHAs0₃), Verdigris (Cu(CH₃C0₂)₂), selected copper phtalocyanines, and Green earth (K[(Al,FeIII),(FeII,Mg](AlSi₃,Si₄)O₁₀(OH)₂);

yellow pigments: aureolin or Cobalt Yellow (PY40; K₃Co(N0₂)₆), Yellow Ochre (PY43; Fe₂0₃·H₂0), Titanium Yellow (PY53; NiO·Sb₂O₃·20TiO₂), and Mosaic gold (SnS₂);

red pigments: Sanguine, Caput Mortuum, Indian Red, Venetian Red, Oxide Red (PRI102; iron oxides), Red Ochre (PR102; anhydrous Fe₂0₃), Burnt Sienna (PBr7; anhydrous Fe₂O₃);

brown pigments: Raw Umber (PBr7; Fe₂0₃+Mn0₂+nH₂0+Si+AI0₃₊), and Raw Sienna (PBr7; limonite clay);

black pigments: Carbon Black (PBk7), Ivory Black (PBk9), Vine Black (PBk8), Lamp Black (PBk6), Mars Black or Iron black (PBk11; Fe₃0₄), manganese dioxide (Mn0₂), and titanium(III)oxide (Ti₂0₃); and

white pigments: stibous oxide (Sb₂0₃), barium sulphate (BaS0₄), lithopone (BaS0₄*ZnS), titanium dioxide (Ti0₂), and zinc oxide (ZnO).

In certain embodiments, the pigment is an organic pigment including but not limited to, azo pigments, phthalocyanines, quiacridone, diaryl pyrrolopyrroles, lithol, toluidine derivatives, pyrazolones, dinitroaniline, Hansa yellow, indanthrenes, dioxazine and benzimidazolone.

In some embodiments, the colorant is a natural or synthetic dye. The skilled artisan having the benefit of the subject description would understand the various types of dyes and their affinities for different substrates based on molecular structure.

Natural dyes can be derived from plant, fungal, mineral and/or animal sources. Non-limiting examples of natural dyes and/or sources of natural dyes include cochineal, lac, urine, murex snail, octopus/cuttlefish, cutch tree, gamboge tree resin, chestnut, rhubarb, Indigofera, kamala seed, madder root, mangosteen, myrobalan, pomegranate, teak leaf, weld, black walnut, sumac tree, Acer sp., Pinus edulis, Rhus trilobata, lupine, Phoradendron juniperinum, Marsdenia, Polygonum tinctorum, Lonchocarpus cyanescens, Acacia spp., kermes, Brazilwood, Lithospermum purpurocaeruleum, mulberry, Genista tinctoria, woad, fustic, iron, corn husk, Artemisia tridentate, red onion, tyrian, saffron, pomegranate, turmeric, safflower, onionskins, weld, quercitron, fustic, butternut, yellow root, Rumex crispus, snake weed, rubber plant, rabbitbush, rose hip, juniper, alder, henna, alkanet, asafetida, sappanwood, Rubia spp., Sarcodon squamosus, Hydnellum geogenium, Hypholoma fasciculare, Phaeolus schqeinitzii, Pisolithus tinctorius, Rocella tinctoria, cudbear, archil, litmus, crottle, wine, grapes, cactus fruit, tea, coffee and blood.

Synthetic dyes can include, but are not limited to, acid or anionic dyes, basic or cationic dyes, azoic or naphthol dyes, direct dyes, disperse dyes, reactive dyes, sulfur dyes, vat dyes, anthraquinones, phthalocyanines and triarylmethanes.

In certain embodiments, the proportion of the colorant contained in the ink is about 0.001 to 20%, about 0.01 to 15%, about 1 to 10%, about 1 to 5%, or about 1 to 2% by weight relative to the total weight of the composition.

The ink compositions of the subject invention can be produced by mixing the colorant with the biological amphiphilic molecule in water and/or another solvent. In some embodiments, the biological amphiphilic molecule forms a micelle in which the colorant is encapsulated. In certain embodiments, the colorant mixture is then added to a water or solvent to produce a water- or solvent-based ink.

Optionally, the composition can also comprise one or more other components or additives, including, for example, carriers, solvents, co-solvents, dispersants, emulsifiers, humectants, binders, wetting agents, biocides, pH modifiers, solubilizers, anti-curl agents, mordants, defoamers, anti-foamers, detergents, plasticizers, waxes, drying agents, chelating agents, viscosity modifiers and/or thickeners. In certain embodiments, the biological amphiphilic molecule can serve the function of one or more of these additives.

In certain specific embodiments, the composition comprises a carrier, solvent and/or co-solvent selected from water, DI water, alcohols such as isopropanol, butanol; diols such as ethylene glycol, diethylene glycol, triethylene glycol, tetraethylene glycol, propylene glycol, dipropylene glycol, tripropylene glycol, 1,2-butanediol, 1,3-butanediol, 1,4-butanediol, thiodiglycol, neopentyl glycol, 1,4-cyclohexanediol and polyethylene glycol; monoalkyl ethers of alkylene glycols, such as ethylene glycol monomethyl ether, ethylene glycol monoethyl ether, ethylene glycol monoisopropyl ether, ethylene glycol monoallyl ether, diethylene glycol monomethyl ether, diethylene glycol monoethyl ether, diethylene glycol monobutyl ether, triethylene glycol monomethyl ether, triethylene glycol monoethyl ether, propylene glycol monomethyl ether and dipropylene glycol monomethyl ether; polyols such as glycerol, 1,2,4-butanetriol, 1,2,5-pentanetriol, 1,2,6-hexanetriol, trimethylolethane, trimethylolpropane and pentaerythritol; cyclic ethers such as tetrahydrofuran and dioxane; and besides dimethyl sulfoxide, diacetone alcohol, glycerol monoallyl ether, N-methyl-2-pyrrolidone, 2-pyrrolidone, γ-butyrolactone, 1,3-dimethyl-2-imidazolidinone, sulfolane, urea, 13-dihydroxyethylurea, acetonylacetone, dimethylformamide, dimethylacetamide and phenoxyethanol.

In certain specific embodiments, the composition comprises a binder selected from resin, acrylics, alkyds, cellulose derivatives, rubber resins, ketones, maleics, formaldehydes, polyurethanes, epoxides, fumarics, hydrocarbons, polyvinyl butyral, polyamids, shallac and phenolics.

Any of the above-listed components can each be present in an amount between 0.001 to 99.9%, 0.01 to 75%, 0.05 to 50%, 0.1 to 25%, or 0.5 to 20% by weight relative to the total weight of the composition.

### Methods

In certain embodiments, methods are provided for improving the environmental impact of printing and/or dyeing surfaces, wherein the method comprises applying a biological amphiphilic molecule according to the subject invention to the surface in place of, and/or in addition to, a chemical active, additive or adjuvant that would traditionally be utilized in one or more compositions and/or steps involved in printing or dyeing.

In certain specific embodiments, the method comprises applying an ink composition according to the subject invention to a surface such that the ink and/or colorant therein become fixed onto or into the surface. In certain embodiments, the biological amphiphilic molecule facilitates delivery of the colorant to the surface prior to fixing of the colorant to the surface. In certain embodiments, the biological amphiphilic molecule serves as one or more of the following purposes: a wetting agent, a solubilizer, a dispersant, an emulsifier, a viscosity modifier, a detergent, a mordant, an anti-foaming agent, and/or a biocide.

The method can comprise applying the ink composition using a printing method selected from, for example, surface printing, relief printing, stamping or block printing, flexographic printing, roller printing, screen printing, heat transfer printing, rotary screen printing, gravure printing, 3D printing and digital printing.

The method can also comprise applying the ink composition using a dyeing method selected from, for example, direct dyeing, stock dyeing of fibers, top dyeing of fibers, yarn dyeing, skein dyeing, package dyeing, warp beam dyeing, garment dyeing, piece dyeing, and vat dyeing. In some embodiments, any one or combination of these methods can be utilized.

The surfaces that can be treated according to the subject invention can include, for example, textiles, paper products, wood, wood veneer, polymers, ceramics, glass, other packaging materials, as well as raw materials thereof.

In general, “textile” refers to any flexible material, such as a fabric, cloth or carpet, created by interlocking yarns or threads, which are produced by spinning raw fibers into long and twisted lengths. The interlocking can be achieved via, for example, weaving, knitting, crocheting, knotting, tatting, felting, bonding or braiding. Textiles can be made of cotton, wool, linen, hemp, sisal, kapok, cellulose, lyocell, polylactate, protein-rich sources (e.g., wool, silk, hair, fur), minerals (e.g., asbestos), and synthetics such as polyester, polyamide, polyacrylonitrile, polypropylene, polyurethane and mixtures thereof. In addition to the flexible material, “textile” as used herein can also include the finished products created using the flexible material, as well as the raw materials involved in producing the flexible materials, including the raw fibers, yarns and threads. In certain embodiments, finished textiles include clothing, garments, upholstery, drapes, carpets and rugs.

Paper products are sheet materials comprised of lignocellulosic fibers, or pulp, derived from wood, rags, grasses, recycled paper, or other plant sources processed in water. Paper products include, but are not limited to, printing papers, wrapping papers, wax papers, kraft papers, writing papers, ledger papers, bank papers, bond papers, blotting papers, drawing papers, handmade papers, tissue papers, cigarette paper, toilet tissue, sanitary products, sand paper, wall paper, paper board, cardboard, and cardstock.

In an exemplary embodiment, the biological amphiphilic molecule serves as a detergent in the washing of the raw material to remove dirt and other contaminants prior to processing.

In another exemplary embodiment the biological amphiphilic molecule serves as a wetting agent for a water or solvent-based ink composition. The biological amphiphilic molecule can lower the surface tension of the water, solvent, or surface to facilitate the delivery and fixing of the colorant to the surface. Advantageously, the wetting agent can improve the receptiveness of the surface with the coloring agent of the ink composition, and facilitate the proper penetration of the colorant into the fiber matrix of the surface.

Advantageously, through use of the biological amphiphilic molecule, traditional chemical wetting agents can be reduced and/or replaced with a low-foaming, high wettability, biodegradable, non-toxic alternative. These traditional wetting agents include but are not limited to acetylenic surfactants such as 3,6-dimethyl-4-octyne-3,6-diol and their ethoxylated analogs; alkyl- and alkylaryl sulphonates; alkyl sulphosuccinates; fluorinated surfactants; poly(alkylene glycol); adducts of poly(oxyalkylene glycol) and fatty acids, fatty alcohols, fatty amines, sorbitan esters, alkanol amides, castor oil; poly(dialkyl-siloxanes); fatty imidazolines; sulphonated fatty esters; phosphated fatty esters; fatty amines and their derivatives; quaternary alkosulphate compounds; poly(propylene oxide)/poly(ethylene oxide) copolymers; alkyl sulphoxides and alkyl sulphones; carboxymethylamylose alkyl sulfate; sulfonates; fatty acid or fatty acid ester sulfates; carboxylic acid soaps; phosphate esters; polyoxyethylene alkyl phenol ethers; polyoxyethylene aliphatic alcohol ethers; polyoxyethylene propylene block copolymers and others.

In another exemplary embodiment, the biological amphiphilic molecule serves as a dispersing agent and/or emulsifier for a water or solvent-based ink composition. During the production of the ink composition, the mixing and/or milling of colorant compounds with a carrier or solvent can be enhanced by the addition of a dispersant to prevent the aggregation of particles. The dispersant can also be useful for supporting the uniformity of application of the pigment and/or dye. Advantageously, this also improves the color intensity, consistency, uniformity, shade and light fastness, as well as prevents clogging of equipment, such as nozzles and screens, with pigment particles. Even further, the dispersant can help balance the surface tension of colorants thereby minimizing inter-color bleeding and mottling.

In certain embodiments, the biological amphiphilic molecule can also serve as a dispersing agent for the printing of coating materials onto paper and textile products. For example, kaolin clay, a particulate mineral, is often used for filling and coating paper to improve appearance, gloss, smoothness, brightness, and opacity. Kaolin also improves the printability of paper. By improving the uniformity of application of the kaolin particles using the biological amphiphilic molecule, less coating is needed and more efficient printing can be achieved.

Advantageously, through use of the biological amphiphilic molecule, traditional chemical dispersants and emulsifiers can be reduced and/or replaced with a low-foaming, high wettability, biodegradable, non-toxic alternative. These traditional dispersants/emulsifiers include but are not limited to sodium alkyl sulphates, sodium dodecylbenzene sulphonate, sodium dodecyl naphthalene sulphate, sodium dodecyl diphenyloxide disulphonate, sodium alkyl sulphosuccinates, potassium N-methyl-N-oleoyl taurate, dialkyl benzenealkyl ammonium chloride, alkylbenzyl methyl ammonium chloride, cetyl pyridinium bromide, alkyl trimethyl ammonium bromides, halide salts of quaternized polyoxyethylalkylamines, dodecylbenzyl triethyl ammonium chloride, polyvinyl alcohol, polyacrylic acid, hydrophobically-substituted polyacryl amide, methyl cellulose, ethyl cellulose, hydroxy ethyl cellulose, carboxy methyl cellulose, polyoxyethylene alkyl ethers, and polyoxyethylene nonylphenyl ether, alkyl or dialkyl phenoxy poly(ethyleneoxy)ethanol derivatives.

In certain embodiments, the biological amphiphilic molecule can serve as a bleed control agent. For example, in some embodiments, the incorporation of dyes and pigments into micelles can slow down diffusion and reduce mobility of the colorant prior to fixing. In the case of soluble dyes, the colorant from one micelle is less likely to exchange with colorant from an adjacent micelle, provided that the setting time is shorter than the time required for the solubilized dye to diffuse through the micelle.

Advantageously, through use of the biological amphiphilic molecule, traditional bleed control agents can be reduced and/or replaced with a low-foaming, high wettability, biodegradable, non-toxic alternative. These traditional bleed controllers include but are not limited to N,N-dimethyl-N-tetradecyl amine oxide; N,N-dimethyl-N-hexadecyl amine oxide; N,N-dimethyl-N-octadecyl amine oxide; and N,N-dimethyl-N-(9-octadecenyl) amine oxide.

In another exemplary embodiment, the biological amphiphilic molecule can serve as a de-foaming and/or anti-foaming agent to de-stabilize foam formation. Additionally, or alternatively, the biological amphiphilic molecule can be utilized as a surfactant in another aspect of the printing or dyeing without excessive foaming or foam stabilization, thereby removing or reducing the requirement for de-foamers and/or anti-foamers, such as, for example, silicon compounds, blends of organic esters in mineral oil base, and EO/PO block copolymers.

In certain embodiments, the biological amphiphilic molecule can be applied as a post-print or post-dye detergent to remove excess components of ink compositions from the surface after drying, curing and/or sealing.

In certain embodiments, the biological amphiphilic molecule can be utilized as a de-inking agent, or detergent, for removing printing ink from waste-paper, waste-paper pulp, textiles, and polymers in preparation for recycling and re-use. The biological amphiphilic molecule can be applied to the material intended to be de-inked, wherein the biological amphiphilic molecule helps detach the ink therefrom. As an example, waste-paper pulp can be mixed with water, and the biological amphiphilic molecule is added to facilitate the flotation of the ink to the surface for removal.

In one embodiment, the method comprises applying the biological amphiphilic molecule to printing and/or dyeing equipment as a detergent or cleaning composition to clean, enhance and/or maintain the performance of the equipment. For example, the equipment can be a roller, a screen, or a nozzle. Advantageously, through use of the biological amphiphilic molecule, traditional chemical detergents can be reduced and/or replaced with a low-foaming, high wettability, biodegradable, non-toxic alternative. These traditional detergents include but are not limited to phosphate esters, polyphosphates, surfynols and acetylenols.

In certain embodiments, the subject methods further comprise testing one or more of print quality, block resistance, foaming, scrubbing, light fastness, bleeding, shear stability, gloss, water resistance, adhesion and drying, and adjusting the process as needed based on testing results. This can include, for example, cleaning equipment and/or adding a biological amphiphilic molecule to one or more steps in the process.

In certain embodiments, the subject invention provides printed and/or dyed goods produced according to the subject methods. For example, in some embodiments, fibers, yarns, threads, fabrics, cloths, carpets, textiles, paper goods, packaging materials, polymers, ceramics, wood, and glass products are provided, wherein these goods are printed with, fixed with, and/or impregnated with an ink composition comprising a biological amphiphilic molecule according to the subject invention. The finished product may comprise, for example, at least 0.0001%, 0.001%, 0.01%, 0.1%, 1%, 2%, 5% or more, by weight, of the biological amphiphilic molecule.

### Biological Amphiphilic Molecules

In certain embodiments, the biological amphiphilic molecule used according to the subject methods is a biosurfactant, meaning a surface-active compound that is produced by a cell and/or produced using naturally-derived substrates. In preferred embodiments, the biosurfactant is produced by a microorganism.

In preferred embodiments, the methods utilize a glycolipid biosurfactant (e.g., sophorolipids, rhamnolipids, cellobiose lipids, mannosylerythritol lipids and/or trehalose lipids). In some embodiments, other biosurfactants can be utilized, such as, for example, lipopeptides (e.g., surfactin, iturin, fengycin, arthrofactin and/or lichenysin), flavolipids, phospholipids (e.g., cardiolipins), fatty acid ester compounds, and high molecular weight polymers such as lipoproteins, lipopolysaccharide-protein complexes, and polysaccharide-protein-fatty acid complexes.

In certain embodiments, the methods utilize a composition comprising one or more sophorolipid (SLP) molecules and/or a yeast culture comprising a SLP molecule. The SLP molecule can be, for example, an acidic (linear) SLP (ASL), lactonic SLP (LSL), di-acetylated SLP, mono-acetylated SLP, esterified SLP, amino-acid-SLP conjugate, metal-SLP conjugate, salt form SLP, SLP amino alcohols, SLP with carbonyl groups removed from the aliphatic chain, and/or any other derivatives of SLP molecules. The SLP molecule(s) can be in a pure form or crude form.

In certain embodiments, the present invention utilizes yeast strains and/or byproducts of their growth. For example, a microbe-based product comprising cultivated Starmerella bombicola ATCC 22214 and/or products of the growth of that microbe, such as SLP, can be used. In certain embodiments, the yeast in the composition can be inactive and/or in various growth states, such as, for example, vegetative or spore forms. In certain other embodiments, the yeast cells are removed from the culture so that broth, microbial growth by-products and, in some instances, trace amounts of residual inactive cellular matter remain for use.

Advantageously, SLP have several benefits making them well-suited for use in the textile and leather making industries. First, their excellent wetting ability helps facilitate a reduction in the usage of water and chemicals, they contribute to reduced water pollution and wastewater treatment due to textile and leather making processes. Additionally, their mildly anionic properties make them compatible with natural and synthetic fibers, and most cationic softeners. Furthermore, SLP are multifunctional, require a low critical micelle concentration (CMC), and are biodegradable.

In preferred embodiments, the subject invention provides methods for producing a “green” surfactant composition having one or more desired functional properties, the methods comprising identifying a biosurfactant molecule having a specific functional property and producing the biosurfactant molecule by cultivating a biosurfactant-producing microorganism under conditions favorable for production of the biosurfactant.

In certain embodiments, the method further comprises combining the biosurfactant molecule with one or more additional biosurfactant molecules, the identity, ratio and/or molecular structure of which are determined based on the desired use(s) for the composition. Thus, a composition is produced having one or more desired functional characteristics, including, for example, surface/interfacial tension reduction, viscosity reduction, emulsification, demulsification, solvency, detergency, and/or antimicrobial action.

In some embodiments, the identity, ratio and/or molecular structure of biosurfactant molecules in the green surfactant composition is determined based on, e.g., HLB, CMC, and/or KB, of the individual molecules. In some embodiments, the identity, ratio and/or molecular structure of biosurfactant molecules is determined based on a theoretical or actual desired HLB, CMC, and/or KB value for the composition as a whole.

In some embodiments, the biological amphiphilic molecules according to the subject invention are particularly useful due to their nanoscale micelle size. Smaller particle sizes are better at penetrating small spaces and pores, such as those found in fibrous materials such as paper and textiles. In certain embodiments, this also contributes to reduced leaching of colorant particles from the material and increased color fastness.

In certain embodiments, the micelle size is less than 1,000 nm, preferably less than 500 nm, more preferably less than 100 nm. In an exemplary embodiment, a sophorolipid according to the subject invention has a micelle size of less than 50 nm, less than 25 nm, or less than 10 nm.

The one or more biosurfactants can be produced using small to large scale cultivation methods. Most notably, the methods can be scaled to an industrial scale, i.e., a scale that is suitable for use in supplying biosurfactants in amounts to meet the demand for commercial applications, for example, production of compositions for enhanced oil recovery. In preferred embodiments, the biosurfactants are produced, optionally modified, and mixed at a centralized location that is, in some embodiments, not more than 300 miles, 200 miles, 100 miles, or 10 miles from where the green surfactant composition will be used.

The microorganisms utilized for producing the biosurfactants may be natural, or genetically modified microorganisms. For example, the microorganisms may be transformed with specific genes to exhibit specific characteristics. The microorganisms may also be mutants of a desired strain. As used herein, “mutant” means a strain, genetic variant or subtype of a reference microorganism, wherein the mutant has one or more genetic variations (e.g., a point mutation, missense mutation, nonsense mutation, deletion, duplication, frameshift mutation or repeat expansion) as compared to the reference microorganism. Procedures for making mutants are well known in the microbiological art. For example, UV mutagenesis and nitrosoguanidine are used extensively toward this end.

In certain embodiments, the microorganisms are bacteria, including Gram-positive and Gram-negative bacteria. The bacteria may be, for example Agrobacterium (e.g., A. radiobacter), Azotobacter (A. vinelandii, A. chroococcum), Azospirillum (e.g., A. brasiliensis), Bacillus (e.g., B. amyloliquefaciens, B. circulans, B. firmus, B. laterosporus, B. licheniforrnis, B. megaterium, B. mojavensis, B. mucilaginosus, B. subtilis), Burkholderia (e.g., B. thailandensis), Frateuria (e.g., F. aurantia), Microbacterium (e.g., M. laevaniformans), myxobacteria (e.g., Myxococcus xanthus, Stignatella aurantiaca, Sorangium cellulosum, Minicystis rosea), Paenibacillus polymyxa, Pantoea (e.g., P. agglomerans), Pseudomonas (e.g., P. aeruginosa, P. chlororaphis subsp. aureofaciens (Kluyver), P. putida), Rhizobium spp., Rhodospirillum (e.g., R. rubrum), Sphingomonas (e.g., S. paucimobilis), and/or Thiobacillus thiooxidans (Acidothiobacillus thiooxidans).

In certain embodiments, the microorganism is a yeast or fungus. Yeast and fungus species suitable for use according to the current invention, include Aureobasidium (e.g., A. pullulans), Blakeslea, Candida (e.g., C. apicola, C. bombicola, C. nodaensis), Cryptococcus, Debaryomyces (e.g., D. hansenii), Entomophthora, Hanseniaspora, (e.g., H. uvarum), Hansenula, Issatchenkia, Kluyveromyces (e.g., K. phaffii), Mortierella, Mycorrhiza, Meyerozyma guilliermondii, Penicillium, Phycomyces, Pichia (e.g., P. anomala, P. guilliermondii, P. occidentalis, P. kudriavzevii), Pleurotus spp. (e.g., P. ostreatus), Pseudozyma (e.g., P. aphidis), Saccharomyces (e.g., S. boulardii sequela, S. cerevisiae, S. torula), Starmerella (e.g., S. bombicola), Torulopsis, Trichoderma (e.g., T. reesei, T. harzianum, T. hamatum, T. viride), Ustilago (e.g., U. maydis), Wickerhamomyces (e.g., W. anomalus), Williopsis (e.g., W. mrakii), Zygosaccharomyces (e.g., Z. bailii), and others.

In preferred embodiments, the microorganism is a yeast or fungus selected from: Starmerella spp. yeasts and/or Candida spp. yeasts, e.g., Starmerella (Candida) bombicola, Candida apicola, Candida batistae, Candida floricola, Candida riodocensis, Candida stellate and/or Candida kuoi. In a specific embodiment, the microorganism is Starmerella bombicola, e.g., strain ATCC 22214.

As used herein “fermentation” refers to growth or cultivation of cells under controlled conditions. The growth could be aerobic or anaerobic. Unless the context requires otherwise, the phrase is intended to encompass both the growth phase and product biosynthesis phase of the process. As used herein, a “broth,” “culture broth,” or “fermentation broth” refers to a culture medium comprising at least nutrients. If the broth is referred to after a fermentation process, the broth may comprise microbial growth byproducts and/or microbial cells as well.

The microbe growth vessel used according to the subject invention can be any fermenter or cultivation reactor for industrial use. As used herein, the term “reactor,” “bioreactor,” “fermentation reactor” or “fermentation vessel” includes a fermentation device consisting of one or more vessels and/or towers or piping arrangements. Examples of such reactor includes, but are not limited to, the Continuous Stirred Tank Reactor (CSTR), Immobilized Cell Reactor (ICR), Trickle Bed Reactor (TBR), Bubble Colunm, Gas Lift Fermenter, Static Mixer, or other vessel or other device suitable for gas-liquid contact. In some embodiments, the bioreactor may comprise a first growth reactor and a second fermentation reactor. As such, when referring to the addition of substrate to the bioreactor or fermentation reaction, it should be understood to include addition to either or both of these reactors where appropriate.

In one embodiment, the method comprises inoculating a fermentation reactor comprising a liquid growth medium with a biosurfactant-producing microorganism to produce a culture; and cultivating the culture under conditions favorable for production of the biosurfactant.

The microbe growth vessel used according to the subject invention can be any fermenter or cultivation reactor for industrial use. In one embodiment, the vessel may have functional controls/sensors or may be connected to functional controls/sensors to measure important factors in the cultivation process, such as pH, oxygen, pressure, temperature, agitator shaft power, humidity, viscosity and/or microbial density and/or metabolite concentration.

In a further embodiment, the vessel may also be able to monitor the growth of microorganisms inside the vessel (e.g., measurement of cell number and growth phases). Alternatively, samples may be taken from the vessel for enumeration, purity measurements, biosurfactant concentration, and/or visible oil level monitoring. For example, in one embodiment, sampling can occur every 24 hours.

The microbial inoculant according to the subject methods preferably comprises cells and/or propagules of the desired microorganism, which can be prepared using any known fermentation method. The inoculant can be pre-mixed with water and/or a liquid growth medium, if desired.

In certain embodiments, the cultivation method utilizes submerged fermentation in a liquid growth medium. In one embodiment, the liquid growth medium comprises a carbon source. The carbon source can be a carbohydrate, such as glucose, dextrose, sucrose, lactose, fructose, trehalose, mannose, mannitol, and/or maltose; organic acids such as acetic acid, fumaric acid, citric acid, propionic acid, malic acid, malonic acid, and/or pyruvic acid; alcohols such as ethanol, propanol, butanol, pentanol, hexanol, isobutanol, and/or glycerol; fats and oils such as canola oil, soybean oil, rice bran oil, olive oil, corn oil, sunflower oil, sesame oil, and/or linseed oil; powdered molasses, etc. These carbon sources may be used independently or in a combination of two or more. In preferred embodiments, a hydrophilic carbon source, e.g., glucose, and a hydrophobic carbon source, e.g., oil or fatty acids, are used.

In one embodiment, the liquid growth medium comprises a nitrogen source. The nitrogen source can be, for example, yeast extract, potassium nitrate, ammonium nitrate, ammonium sulfate, ammonium phosphate, ammonia, urea, and/or ammonium chloride. These nitrogen sources may be used independently or in a combination of two or more.

In one embodiment, one or more inorganic salts may also be included in the liquid growth medium. Inorganic salts can include, for example, potassium dihydrogen phosphate, monopotassium phosphate, dipotassium hydrogen phosphate, disodium hydrogen phosphate, potassium chloride, magnesium sulfate, magnesium chloride, iron sulfate, iron chloride, manganese sulfate, manganese chloride, zinc sulfate, lead chloride, copper sulfate, calcium chloride, calcium carbonate, calcium nitrate, magnesium sulfate, sodium phosphate, sodium chloride, and/or sodium carbonate. These inorganic salts may be used independently or in a combination of two or more.

In one embodiment, growth factors and trace nutrients for microorganisms are included in the medium. This is particularly preferred when growing microbes that are incapable of producing all of the vitamins they require. Inorganic nutrients, including trace elements such as iron, zinc, copper, manganese, molybdenum and/or cobalt may also be included in the medium. Furthermore, sources of vitamins, essential amino acids, proteins and microelements can be included, for example, corn flour, peptone, yeast extract, potato extract, beef extract, soybean extract, banana peel extract, and the like, or in purified forms. Amino acids such as, for example, those useful for biosynthesis of proteins, can also be included.

The method of cultivation can further provide oxygenation to the growing culture. One embodiment utilizes slow motion of air to remove low-oxygen containing air and introduce oxygenated air. The oxygenated air may be ambient air supplemented daily through mechanisms including impellers for mechanical agitation of the liquid, and air spargers for supplying bubbles of gas to the liquid for dissolution of oxygen into the liquid. In certain embodiments, dissolved oxygen (DO) levels are maintained at about 25% to about 75%, about 30% to about 70%, about 35% to about 65%, about 40% to about 60%, or about 50% of air saturation.

In some embodiments, the method for cultivation may further comprise adding additional acids and/or antimicrobials in the liquid medium before and/or during the cultivation process. Antimicrobial agents or antibiotics (e.g., streptomycin, oxytetracycline) are used for protecting the culture against contamination. In some embodiments, however, the metabolites produced by the yeast culture provide sufficient antimicrobial effects to prevent contamination of the culture.

In one embodiment, prior to inoculation, the components of the liquid culture medium can optionally be sterilized. In one embodiment, sterilization of the liquid growth medium can be achieved by placing the components of the liquid culture medium in water at a temperature of about 85-100° C. In one embodiment, sterilization can be achieved by dissolving the components in 1 to 3% hydrogen peroxide in a ratio of 1:3 (w/v).

In one embodiment, the equipment used for cultivation is sterile. The cultivation equipment such as the reactor/vessel may be separated from, but connected to, a sterilizing unit, e.g., an autoclave. The cultivation equipment may also have a sterilizing unit that sterilizes in situ before starting the inoculation. Gaskets, openings, tubing and other equipment parts can be sprayed with, for example, isopropyl alcohol. Air can be sterilized by methods know in the art. For example, the ambient air can pass through at least one filter before being introduced into the vessel. In other embodiments, the medium may be pasteurized or, optionally, no heat at all added, where the use of pH and/or low water activity may be exploited to control unwanted microbial growth.

The pH of the culture should be suitable for the microorganism of interest, and can be altered as desired in order to produce a specific biosurfactant molecule in the culture. Buffers, and pH regulators, such as carbonates and phosphates, may be used to stabilize pH near a preferred value.

In some embodiments, the pH is about 2.0 to about 7.0. In some embodiments, the pH is about 2.5 to about 5.5, about 3.0 to about 4.5, or about 3.5 to about 4.0. In one embodiment, the cultivation may be carried out continuously at a constant pH. In another embodiment, the cultivation may be subject to changing pH.

In one embodiment, the method of cultivation is carried out at about 5° to about 100° C., about 15° to about 60° C., about 20° to about 45° C., about 22° to about 30° C., or about 24° to about 28° C. In one embodiment, the cultivation may be carried out continuously at a constant temperature. In another embodiment, the cultivation may be subject to changing temperatures.

According to the subject methods, the microorganisms can be incubated in the fermentation system for a time period sufficient to achieve a desired effect, e.g., production of a desired amount of cell biomass or a desired amount of one or more microbial growth by-products. The microbial growth by-product(s) produced by microorganisms may be retained in the microorganisms and/or secreted into the growth medium. The biomass content may be, for example from 5 g/l to 180 g/l or more, or from 10 g/l to 150 g/l.

In certain embodiments, fermentation of the culture occurs for about 48 to 150 hours, or about 72 to 150 hours, or about 96 to about 125 hours, or about 110 to about 120 hours.

After the fermentation cycle is complete, the method can comprise, in some embodiments, extracting, concentrating and/or purifying the biosurfactant molecule.

In certain embodiments, the methods of the subject invention can be carried out in such a way that minimal-to-zero waste products are produced, thereby reducing the amount of fermentation waste being drained into sewage and wastewater systems, and/or being disposed of in landfills.

The cell biomass collected from the culture after extraction of the biosurfactant would typically be inactivated and disposed of. However, the subject methods can further comprise collecting the cell biomass and using it, in live or inactive form, for a variety of purposes, including but not limited to, as a soil amendment, a livestock feed supplement, an oil well treatment, and/or a skincare product. The cell biomass can be used directly, or it can be mixed with additives specific for the intended use.

In some embodiments, water or other non-toxic liquids used to extract and/or purify the biosurfactant can contain residual biosurfactants, nutrients and/or cell matter. Thus, in certain embodiments, the liquids can be used in irrigation drip lines or sprinklers as a soil or foliar treatment for plants; as a safe nutritional and/or hydration supplement for humans and animals; as a cleaning composition; and/or for countless other uses to reduce fermentation waste products.

In some embodiments, the method comprises modifying the structure of a biosurfactant molecule prior to adding it to the composition.

In some embodiments, adjusting the parameters of fermentation results in modification and/or production of one or more specific biosurfactant molecules in the culture, and/or production of a specific ratio of multiple biosurfactant molecules. These parameters can include, for example, using a specific strain of microorganism, adjusting the growth medium composition, co-cultivating the microbe with an antagonistic and/or influencing microbe, adding inhibitors and/or stimulant compounds to the nutrient medium, adjusting the temperature, pH and/or aeration of fermentation, and others.

In some embodiments, the biosurfactant molecule(s) obtained from the fermentation cycle can be modified post-fermentation by, for example, esterification, polymerization, addition of amino acids, addition of metals, and alteration of fatty acid chain lengths.

In additional and/or alternative embodiments, the composition can be tailored to have a specific, and in some instances, very precise, HLB value based on the identity and ratio of biosurfactant molecules within the composition.

In certain embodiments, the composition comprises one or more biosurfactant molecules belonging to a class selected from, for example, glycolipids, lipopeptides, flavolipids, phospholipids, fatty acid ester compounds, lipoproteins, lipopolysaccharide-protein complexes, and polysaccharide-protein-fatty acid complexes.

In some embodiments, the composition comprises multiple biosurfactant molecules belonging to the same biosurfactant class. In some embodiments, the composition comprises biosurfactant molecules belonging to more than one of these biosurfactant classes.

In some embodiments, the composition comprises a glycolipid, such as, for example, a sophorolipid, rhamnolipid, trehalose lipid, cellobiose lipid and/or mannosylerythritol lipid.

In a specific embodiment, the composition can comprise 0% to 100%, 5% to 95%, 10% to 90%, 15% to 85%, 20% to 80%, 25% to 75%, 30% to 70%, 35% to 65%, 40% to 60%, 45% to 55%, or 50%, by weight, a sophorolipid molecule as defined elsewhere herein.

In one embodiment, the composition comprises lactonic SLP and linear SLP at a ratio of 0.1% lactonic to 99.9% linear (with respect to total SLP), 0.5% lactonic to 99.5% linear, 1% lactonic to 99% linear, 5% lactonic to 95% linear, 10% lactonic to 90% linear, 20% lactonic to 80% linear, 30% lactonic to 70% linear, 40% lactonic to 60% linear, 50% lactonic to 50% linear, 60% lactonic to 40% linear, 70% lactonic to 30% linear, 80% lactonic to 20% linear, 90% lactonic to 10% linear, 95% lactonic to 5% linear, 99% lactonic to 1% linear, 99.5% lactonic to 0.5% linear, or 99.9% lactonic to 0.1% linear. In a specific embodiment, the composition can comprise 0% to 100%, 5% to 95%, 10% to 90%, 15% to 85%, 20% to 80%, 25% to 75%, 30% to 70%, 35% to 65%, 40% to 60%, 45% to 55%, or 50%, by weight, a rhamnolipid molecule. A “rhamnolipid” or a “rhamnolipid molecule” can include, for example, mono- and di-rhamnolipids, and all possible derivatives therein, as well as other forms as described herein.

In a specific embodiment, the composition can comprise 0% to 100%, 5% to 95%, 10% to 90%, 15% to 85%, 20% to 80%, 25% to 75%, 30% to 70%, 35% to 65%, 40% to 60%, 45% to 55%, or 50%, by weight, a mannosylerythritol lipid molecule. A “mannosylerythritol lipid” or a “mannosylerythritol lipid molecule” can include, for example, tri-acylated, di-acylated, mono-acylated, tri-acetylated, di-acetylated, mono-acetylated and non-acetylated MEL, as well as stereoisomers and/or constitutional isomers thereof. In certain specific embodiments, the MEL are characterized as groups: MEL A (di-acetylated), MEL B (mono-acetylated at C4), MEL C (mono-acetylated at C6), MEL D (non-acetylated), tri-acetylated MEL A, tri-acetylated MEL B/C, as well as other forms as described herein.

In some embodiments, the composition comprises 0% to 100%, 5% to 95%, 10% to 90%, 15% to 85%, 20% to 80%, 25% to 75%, 30% to 70%, 35% to 65%, 40% to 60%, 45% to 55%, or 50%, by weight, a lipopeptide, such as, for example, a surfactin, fengycin, arthrofactin, lichenysin, iturin and/or viscosin.

In some embodiments, two or more purified biosurfactant molecules are mixed with one another. In some embodiments, two or more unpurified, or crude form, biosurfactants are mixed with one another, wherein the crude form can comprise, for example, residual nutrient medium, microbial cells, and/or other microbial metabolites produced during fermentation. In some embodiments, a purified biosurfactant molecule can be mixed with a crude form biosurfactant. In some embodiments, a derivatized biosurfactant molecule can be mixed with another derivatized biosurfactant, a purified non-derivatized biosurfactant, and/or a crude form biosurfactant.

### Preparation of Microbe-based Products

One microbe-based product of the subject invention is simply the fermentation medium containing the microorganisms and/or the microbial metabolites produced by the microorganisms and/or any residual nutrients. The product of fermentation may be used directly without extraction or purification. If desired, extraction and purification can be easily achieved using standard extraction and/or purification methods or techniques described in the literature.

The microorganisms in the microbe-based products may be in an active or inactive form, or in the form of vegetative cells, reproductive spores, conidia, mycelia, hyphae, or any other form of microbial propagule. The microbe-based product may also comprise the broth and/or growth by-products with the microbes removed therefrom.

The microbe-based products may be used without further stabilization, preservation, and storage. Advantageously, direct usage of these microbe-based products preserves a high viability of the microorganisms, reduces the possibility of contamination from foreign agents and undesirable microorganisms, and maintains the activity of the by-products of microbial growth.

Upon harvesting the microbe-based composition from the growth vessels, further components can be added as the harvested product is placed into containers or otherwise transported for use. The additives can be, for example, buffers, carriers, other microbe-based compositions produced at the same or different facility, viscosity modifiers, preservatives, nutrients for microbe growth, surfactants, emulsifying agents, lubricants, solubility controlling agents, tracking agents, solvents, biocides, antibiotics, pH adjusting agents, chelators, stabilizers, ultra-violet light resistant agents, other microbes and other suitable additives that are customarily used for such preparations.

In one embodiment, buffering agents including organic and amino acids or their salts, can be added. Suitable buffers include citrate, gluconate, tartarate, malate, acetate, lactate, oxalate, aspartate, malonate, glucoheptonate, pyruvate, galactarate, glucarate, tartronate, glutamate, glycine, lysine, glutamine, methionine, cysteine, arginine and a mixture thereof. Phosphoric and phosphorous acids or their salts may also be used. Synthetic buffers are suitable to be used but it is preferable to use natural buffers such as organic and amino acids or their salts listed above.

In a further embodiment, pH adjusting agents include potassium hydroxide, ammonium hydroxide, potassium carbonate or bicarbonate, hydrochloric acid, nitric acid, sulfuric acid or a mixture.

The pH of the microbe-based composition should be suitable for the microorganism(s) of interest. In some embodiments, the pH of the composition is about 3.5 to 7.0, about 4.0 to 6.5, or about 5.0.

In one embodiment, additional components such as an aqueous preparation of a salt, such as sodium bicarbonate or carbonate, sodium sulfate, sodium phosphate, sodium biphosphate, can be included in the formulation.

Optionally, the product can be stored prior to use. The storage time is preferably short. Thus, the storage time may be less than 60 days, 45 days, 30 days, 20 days, 15 days, 10 days, 7 days, 5 days, 3 days, 2 days, 1 day, or 12 hours. In a preferred embodiment, if live cells are present in the product, the product is stored at a cool temperature such as, for example, less than 20° C., 15° C., 10° C., or 5° C.

### Local Production of Microbe-Based Products

In certain embodiments of the subject invention, a microbe growth facility produces fresh, high-density microorganisms and/or microbial growth by-products of interest on a desired scale. The microbe growth facility may be located at or near the site of application. The facility produces high-density microbe-based compositions in batch, quasi-continuous, or continuous cultivation.

The microbe growth facilities of the subject invention can be located at the location where the microbe-based product will be used. For example, the microbe growth facility may be less than 300, 250, 200, 150, 100, 75, 50, 25, 15, 10, 5, 3, or 1 mile from the location of use.

Because the microbe-based product can be generated locally, without resort to the microorganism stabilization, preservation, storage and transportation processes of conventional microbial production, a much higher density of microorganisms can be generated, thereby requiring a smaller volume of the microbe-based product for use in the on-site application or which allows much higher density microbial applications where necessary to achieve the desired efficacy. This makes the system efficient and can eliminate the need to stabilize cells or separate them from their culture medium. Local generation of the microbe-based product also facilitates the inclusion of the growth medium in the product. The medium can contain agents produced during the fermentation that are particularly well-suited for local use.

Locally-produced high density, robust cultures of microbes are more effective in the field than those that have remained in the supply chain for some time. The microbe-based products of the subject invention are particularly advantageous compared to traditional products wherein cells have been separated from metabolites and nutrients present in the fermentation growth media. Reduced transportation times allow for the production and delivery of fresh batches of microbes and/or their metabolites at the time and volume as required by local demand.

The microbe growth facilities of the subject invention produce fresh, microbe-based compositions, comprising the microbes themselves, microbial metabolites, and/or other components of the medium in which the microbes are grown. If desired, the compositions can have a high density of vegetative cells or propagules (e.g., spores), or a mixture of vegetative cells and propagules.

In one embodiment, the microbe growth facility is located on, or near, a site where the microbe-based products will be used, for example, within 300 miles, 200 miles, or even within 100 miles. Advantageously, this allows for the compositions to be tailored for use at a specified location. The formula and potency of microbe-based compositions can be customized for a specific application and in accordance with the local conditions at the time of application.

Advantageously, distributed microbe growth facilities provide a solution to the current problem of relying on far-flung industrial-sized producers whose product quality suffers due to upstream processing delays, supply chain bottlenecks, improper storage, and other contingencies that inhibit the timely delivery and application of, for example, a viable, high cell-count product and the associated medium and metabolites in which the cells are originally grown.

Furthermore, by producing a composition locally, the formulation and potency can be adjusted in real time to a specific location and the conditions present at the time of application. This provides advantages over compositions that are pre-made in a central location and have, for example, set ratios and formulations that may not be optimal for a given location.

The microbe growth facilities provide manufacturing versatility by their ability to tailor the microbe-based products to improve synergies with destination geographies. Advantageously, in preferred embodiments, the systems of the subject invention harness the power of naturally-occurring local microorganisms and their metabolic by-products.

Local production and delivery within, for example, 24 hours of fermentation results in pure, high cell density compositions and substantially lower shipping costs. Given the prospects for rapid advancement in the development of more effective and powerful microbial inoculants, consumers will benefit greatly from this ability to rapidly deliver microbe-based products.

### Replacing Chemical Surfactants

In preferred embodiments, the subject green surfactant composition can be utilized in place of chemical surfactant(s) in products that would typically comprise the chemical surfactant(s), where one or more biosurfactants are chosen that have the same or similar functional properties as the chemical surfactant(s).

Thus, in some embodiments, the methods comprise selecting a known composition comprising one or more chemical surfactants and, optionally, one or more additional components, and producing an environmentally-friendly version of the known composition by using a green surfactant composition of the subject invention in place of the chemical surfactant(s). The green surfactant composition can be mixed with the one or more optional additional components, if present.

In certain embodiments, the compositions can be used to replace compositions comprising chemical surfactants. Typical chemical or synthetic surfactants (meaning, non-biological surfactants) comprise a hydrophobic group, which is usually a long hydrocarbon chain (C8-C18) that may or may not be branched, while the hydrophilic group is formed by moieties such as carboxylates, sulfates, sulfonates (anionic), alcohols, polyoxyethylenated chains (nonionic) and quaternary ammonium salts (cationic).

Non-biological surfactants that can be replaced in surfactant compositions utilizing the methods and compositions of the subject invention include, but are not limited to: anionic surfactants, ammonium lauryl sulfate, sodium lauryl sulfate (also called SDS, sodium dodecyl sulfate), alkyl-ether sulfates sodium laureth sulfate (also known as sodium lauryl ether sulfate (SLES)), sodium myreth sulfate; docusates, dioctyl sodium sulfosuccinate, perfluorooctanesulfonate (PFOS), perfluorobutanesulfonate, linear alkylbenzene sulfonates (LABs), alkyl-aryl ether phosphates, alkyl ether phosphate; carboxylates, alkyl carboxylates (soaps), sodium stearate, sodium lauroyl sarcosinate, carboxylate-based fluorosurfactants, perfluorononanoate, perfluorooctanoate; cationic surfactants, pH-dependent primary, secondary, or tertiary amines, octenidine dihydrochloride, permanently charged quaternary ammonium cations, alkyltrimethylammonium salts, cetyl trimethylammonium bromide (CTAB) (a.k.a. hexadecyl trimethyl ammonium bromide), cetyl trimethylammonium chloride (CTAC), cetylpyridinium chloride (CPC), benzalkonium chloride (BAC), benzethonium chloride (BZT), 5-Bromo-5-nitro-1,3-dioxane, dimethyldioctadecylammonium chloride, cetrimonium bromide, dioctadecyldi-methylammonium bromide (DODAB); zwitterionic (amphoteric) surfactants, sultaines CHAPS (3-[(3-Cholamidopropyl)dim ethylammonio]-1-propanesulfonate), cocamidopropyl hydroxysultaine, betaines, cocamidopropyl betaine, phosphatidylserine, phosphatidylethanolamine, phosphatidylcholine, sphingomyelins; nonionic surfactants, ethoxylates (e.g., alcohol ethoxylates), long chain alcohols, fatty alcohols, cetyl alcohol, stearyl alcohol, cetostearyl alcohol, oleyl alcohol, polyoxyethylene glycol alkyl ethers (Brij): CH3-(CH2)10-16-(O—C2H4)1-25-OH (octaethylene glycol monododecyl ether, pentaethylene glycol monododecyl ether), polyoxypropylene glycol alkyl ethers: CH3-(CH2)10-16-(O—C3H6)1-25-OH, glucoside alkyl ethers: CH3-(CH2)10-16-(O-Glucoside)1-3-OH (decyl glucoside, lauryl glucoside, octyl glucoside), polyoxyethylene glycol octylphenol ethers: C8H17-(C61-14)—(O—C2H4)1-25-OH (Triton X-100), polyoxyethylene glycol alkylphenol ethers: C9H19-(C6H4)—(O—C2H4)1-25-OH (nonoxynol-9), glycerol alkyl esters (glyceryl laurate), polyoxyethylene glycol sorbitan alkyl esters (polysorbate), sorbitan alkyl esters (spans), cocamide MEA, cocamide DEA, dodecyldimethylamine oxide, copolymers of polyethylene glycol and polypropylene glycol (poloxamers), and polyethoxylated tallow amine (POEA).

Anionic surfactants contain anionic functional groups at their head, such as sulfate, sulfonate, phosphate, and carboxylates. Prominent alkyl sulfates include ammonium lauryl sulfate, sodium lauryl sulfate (also called SDS, sodium dodecyl sulfate) and the related alkyl-ether sulfates sodium laureth sulfate, also known as sodium lauryl ether sulfate (SLES), and sodium myreth sulfate. Carboxylates are the most common surfactants and comprise the alkyl carboxylates (soaps), such as sodium stearate.

Surfactants with cationic head groups include: pH-dependent primary, secondary, or tertiary amines; octenidine dihydrochloride; permanently charged quaternary ammonium cations such as alkyltrimethylammonium salts: cetyl trimethylammonium bromide (CTAB) a.k.a. hexadecyl trimethyl ammonium bromide, cetyl trimethylammonium chloride (CTAC); cetylpyridinium chloride (CPC); benzalkonium chloride (BAC); benzethonium chloride (BZT); 5-Bromo-5-nitro-1,3-dioxane; dimethyldioctadecylammonium chloride; cetrimonium bromide; and dioctadecyldi-methylammonium bromide (DODAB).

Zwitterionic (amphoteric) surfactants have both cationic and anionic centers attached to the same molecule. The cationic part is based on primary, secondary, or tertiary amines or quaternary ammonium cations. The anionic part can be more variable and include sulfonates. Zwitterionic surfactants commonly have a phosphate anion with an amine or ammonium, such as is found in the phospholipids phosphatidylserine, phosphatidylethanolamine, phosphatidylcholine, and sphingomyelins.

A surfactant with a non-charged hydrophilic part, e.g. ethoxylate, is non-ionic. Many long chain alcohols exhibit some surfactant properties.

### EXAMPLES

A greater understanding of the present invention and of its many advantages may be had from the following examples, given by way of illustration. The following examples are illustrative of some of the methods, applications, embodiments and variants of the present invention. They are not to be considered as limiting the invention. Numerous changes and modifications can be made with respect to the invention.

### Example 1—Sophorolipid Production

To produce SLP, a fermentation reactor is inoculated with a Starmerella bombicola yeast. The temperature of fermentation is held at 23 to 28° C. After about 22 to 26 hours, the pH of the culture is set to about 3.0 to 4.0, or about 3.5, using 20% NaOH. The fermentation reactor comprises a computer that monitors the pH and controls the pump used to administer the base, so that the pH remains at 3.5.

After about 6-7 days of cultivation (120 hours+1-1 hour), if 7.5 ml of a SLP layer is visible with no oil visible and no glucose detected, the batch is ready for harvesting.

### Modifying SLP Products During Fermentation

The structure of the SLP molecules produced by the subject methods can be modified in multiple ways by altering fermentation parameters. One approach is to include long-chain fatty alcohols (e.g., C4 to C26-alcohols) in the nutrient medium. The resulting SLP molecules will comprise hydrophobic moieties up to C36 in length, and will increase the hydrophobicity, emulsification and detergency capabilities of the composition.

Another approach is to limit the amount of sugar and/or oil in the fermentation medium. For example, in some embodiments, the amount of glucose is limited to about 25 g/L to about 75 g/L and/or the amount of canola oil is limited to about 25 ml/L to about 75 ml/L. In certain embodiments, this will increase the amount of ASL produced in the culture.

To increase the amount of hydrophobic SLP molecules (e.g., LSL and some ASL) the yeast is cultivated at a temperature of about 22° C. to about 28° C., and at a pH of about 2.5 to 4.0, where the pH begins at about 4.0 and reduces to—and is stabilized at—about 2.5 during cultivation.

To increase the amount of ASL in the culture, the yeast is cultivated at a pH of about 5.5, and at a temperature of about 35° C. Additionally, utilizing the yeast Candida kuoi can result in a composition comprising only ASL, as this yeast only produces ASL.

Modifying SLP Products after Fermentation

Some modifications of SLP molecules occur after the cultivation cycle is ended. For example, inorganic acids, alkaline substances and/or salts can be mixed with SLP to alter solubility.

Furthermore, in addition to SLP, the yeasts also produce enzymes, such as lipases and esterases, into the yeast culture. Certain enzymes catalyze the bonding of amino acids to the SLP molecules. Thus, amino acids can be added to the yeast culture, and are chosen based on the character of the amino acid and the desired character of the SLP molecule(s). Cationic, anionic, polar and non-polar amino acids and amino alcohols, when bonded to the SLP molecules, can alter the properties of the SLP molecules to be, for example, cationic, anionic, polar or non-polar. This can also be achieved using synthetic means.

Additionally, certain enzymes catalyze the esterification of the SLP molecules in the presence of the alcohol and fatty acid.

When the fermentation cycle is completed, an alcohol (e.g., 10% v/v) selected from methanol, ethanol, isopropyl alcohol, hexanol, or heptanol is added to the yeast culture. The liquid fermentation medium preferably already comprises a source of fatty acids, for example, canola oil. However, additional fatty acids can be added if a certain esterified product is desired, for example, purified forms of fatty acids such as palmitic, stearic, oleic, linoleic, linolenic, ricinoleic, lauric, and myristic acids.

The yeast culture with alcohol and fatty acid is mixed for 24 hours. After 24 hours, mixing is stopped and the culture will contain SLP esters containing an added alcohol, a sophorose, and a fatty acid ester, e.g., methanol sophorolipid oleic acid ester, which is formed when methanol and oleic acid are used.

1. A method for printing and/or dyeing a surface, the method comprising applying a biological amphiphilic molecule and a colorant to the surface, wherein the biological amphiphilic molecule serves as an adjuvant, an additive and/or an active ingredient involved in delivery and fixing of the colorant to the surface.

2. The method of claim 1, wherein the biological amphiphilic molecule functions as a detergent, a dispersant, an emulsifier, a wetting agent, a biocide, a de-foamer, and/or a binder.

3. The method of claim 1, wherein the biological amphiphilic molecule functions as an adjuvant or additive for improving the performance of carriers, solvents, co-solvents, dispersants, emulsifiers, humectants, binders, wetting agents, biocides, pH modifiers, solubilizers, anti-curl agents, mordants, defoamers, anti-foamers, detergents, plasticizers, waxes, drying agents, chelating agents, viscosity modifiers and/or thickeners.

4. The method of claim 1, wherein the surface is a textile, paper, polymer, wood, glass, ceramic, packaging material, or raw material thereof.

5. The method of claim 1, wherein the biological amphiphilic molecule is a biosurfactant.

6. The method of claim 5, wherein the biosurfactant is a glycolipid biosurfactant selected from sophorolipids, rhamnolipids, cellobiose lipids, mannosylerythritol lipids and trehalose lipids, a lipopeptide selected from surfactin, iturin, fengycin, arthrofactin and lichenysin, a flavolipid, a phospholipid, a fatty acid ester, or a high molecular weight polymer selected from lipoproteins, lipopolysaccharide-protein complexes, and polysaccharide-protein-fatty acid complexes.

7. The method of claim 6, wherein the biosurfactant is a sophorolipid.

8. The method of claim 7, wherein the biosurfactant is in a purified form.

9. The method of claim 7, wherein the biosurfactant was produced by fermentation of Starmerella bombicola, and wherein the method comprises applying the biosurfactant in the form of a broth resulting from the fermentation.

10. The method of claim 9, wherein the broth comprises yeast cell matter.

11. The method of claim 1, wherein water usage is reduced as a result of application of the biological amphiphilic molecule.

12. The method of claim 1, wherein chemical usage is reduced as a result of application of the biological amphiphilic molecule.

13. The method of claim 1, wherein water pollution is reduced as a result of application of the biological amphiphilic molecule.

14. An ink composition comprising a biological amphiphilic molecule, a colorant and a carrier, wherein the colorant is a pigment or a dye, and wherein the carrier is water or a solvent.

15. The ink composition of claim 14, further comprising one or more components selected from: carriers, solvents, co-solvents, dispersants, emulsifiers, humectants, binders, wetting agents, biocides, pH modifiers, solubilizers, anti-curl agents, mordants, defoamers, anti-foamers, detergents, plasticizers, waxes, drying agents, chelating agents, viscosity modifiers and/or thickeners.

16. A textile good comprising yarn, thread, fabric, cloth, or a finished product produced from yard, thread, fabric, and/or cloth, wherein the yarn, thread, fabric, cloth is impregnated with, printing with and/or coated with a biological amphiphilic molecule and a colorant.

17. The textile good of claim 16, wherein the biological amphiphilic molecule is a sophorolipid.

18. The textile good of claim 16, wherein the finished product is selected from clothing, garments, upholstery, drapes, carpets and rugs.

19. A paper good comprising lignocellulosic fibers, or a finished product produced from lignocellulosic fibers, wherein the fiber is impregnated with, printed with and/or coated with a biological amphiphilic molecule and a colorant.

20. The paper good of claim 19, wherein the biological amphiphilic molecule is a sophorolipid.

21. The paper good of claim 19, wherein the finished product is selected from cardboard, printer paper, sanitary paper, tissue paper, boxes, wrapping paper, newsprint, cardstock, and handmade paper.

22. A method for de-inking a surface, the method comprising applying a biological amphiphilic molecule the surface such that the biological amphophilic molecule contacts the ink, allowing the ink to separate from the surface, and collecting the ink.

23. The method of claim 22, wherein the surface is waste-paper, plastic, or textiles.

24. The method of claim 22, used to clean an ink stain.

25. (canceled)

26. The method of claim 22, wherein the biological amphiphilic molecule is a sophorolipid.
